(19) United States
(12) Patent Application Publication
(10) Pub. No.: US 2009/0254974 A1
(43) Pub. Date: Oct. 8, 2009

(54) Method and Apparatus for Open Internet Security for Mobile Wireless Devices

(76) Inventors: Christopher M. McGregor, San Francisco, CA (US); Gregory M. McGregor, Walnut Creek, CA (US)

Correspondence Address: Richard Peterson, 1905 d Palmetto Ave, Pacifica, CA, 94044, US

(21) Appl. No.: 10/590,094

(22) PCT Filed: Feb. 18, 2005
(86) PCT No.: PCT/US05/05318

§ 371 Date: Jul. 28, 2008

(51) Int. Cl. G06F 11/30; H04L 9/00

(52) U.S. Cl. 726/3; 455/558

(57) ABSTRACT

A method and apparatus for a wireless communication network with mobile wireless devices, where the wireless communication network is at least in part controlled by a wireless network service provider that provides wireless network services to subscribers, the wireless devices including terminals capable of communication in the wireless communication network and capable of connecting to the Internet, each terminal having a removable USIM under the control of the wireless network service provider, wherein the USIM is provided to a subscriber for installation in the subscriber's terminal for controlling the terminal's access to the service provider's wireless communication network and to the Internet.

### BACKGROUND OF THE INVENTION

The invention relates to subscriber account management in a wireless network and in particular to distributed account control for Internet access by wireless devices having internet capabilities.

The distributed account control system of this invention identifies certain control points in a wireless communication system that connects subscribers to other subscribers or to service providers, including content providers and providers of commercial goods and services through the Internet.

Subscriber account management in the distributed account control system of this invention focuses on quality of service issues for wireless service providers offering internet connection through access control and transaction analysis at control points that are removed from the typical Internet service provider or the wireless network service provider.

As wireless telephones migrate from analog to digital communication networks, the technical barriers to connecting state-of-the-art wireless telephones to the world wide web are eliminated.

However, wireless telephones and other wireless devices, particularly compact handheld units, generally lack the capabilities of typical computers that are connected to the Internet by land lines. With small screens and low data transfer rates, the rich environment of the Internet is largely unavailable to the wireless terminal. Even implementation of existing standards, such as WAP, for delivery of Internet content to wireless devices is slow, in part because of the limited number of devices capable of accessing the Internet. Content providers on Internet sites would adept to device limitations if the number of users increased since ultimately it is the users, not the particular access device, that the content providers are trying to reach.

Once a threshold is reached in the number of users of wireless mobile devices having Internet connection capabilities, there will be an explosion in the number of Internet sites delivering content services and product tailored to the mobile wireless terminal. This will result in a cascade effect that will overwhelm existing wireless communication networks that are already limited in bandwidth. As bandwidth demand increases, quality of service will diminish without drastic steps being taken by the service provider of the mobile device. Service levels that are adequate for oral communications will fail in network systems where voice is only one part of a rich media delivery.

Many of the solutions for quality of service problems in mobile wireless devices that are migrating from 1G and 2G systems to 2.5G and 3G systems are described in McGregor, et al., U.S. application Ser. No. 10/393,600, filed Mar. 20, 2003, and published on Mar. 25, 2004, as Pub. No. U.S. 2004/0058652 A1. In the McGregor, et al. reference, methods for task allocation between the service provider and wireless mobile device are discussed for optimizing the quality of service experienced by the subscriber.

However, when moving to wireless mobile devices having Internet access capabilities, quality of service issues related to access and delivery of Internet offerings will not be addressed by the Internet content service and product providers, but befall to the wireless service provider. To avoid chaos and adverse impact on the service provider burdened with an increase in quality of service problems outside of its control, access to the Internet by the Internet capable wireless mobile device must be controlled. This is accomplished by first identifying the control points in the Internet network.

### Control Points

Control point are locations within the network where Internet access can be controlled. Control points are important and, depending on how the control point is implemented, there are profound technical advantages and disadvantages to each. To better understand control points, let us take two extreme control point implementations. On one extreme, 3G wireless networks might decide to not offer any Internet access at all. By offering no access, there are virtually no security risks. However, another type of control point might be an “open” policy where any end user can access all Internet services and content. In this model, there are larger security risks due to the lack of control on user access. In between each of these models are various places in which control can be enforced. Each of those places is called a control point.

### Open Internet

Open Internet provides no restrictions over the subscriber as to what content they can access or purchase, nor does it limit in any way the ability for the user to connect to various Internet services. In this model, there are no control points used to govern Internet access. Access to services such as POP3, SMTP, HTTP and other services are allowed. In this model, shown in FIG. 1, the end user terminals are opened up to consume Internet services at their leisure with little restriction. In this model, the security and control are left open to the end user. This means that email, downloaded executable modules and further customization of the terminal are allowed and that there is little control over what the user attempts to access on the Internet. For instance, if an end user wishes to access their POP3 email or send via SMTP, that is allowed. Furthermore, users are allowed to access all “Content-Types” via HTTP.

In general, Open Internet is similar to a typical to non-proxy based Internet browsing via a PC.

### Open Internet-Network Flow

In an Open Internet model, the network flow is fundamentally uninhibited. The terminal is free to acquire an IP address and connect via IP, using TCP/UDP to various protocol ports and protocols to consume services. For instance, the terminal may include a POP3 email client that is allowed to connection to POP3 (typically TCP port 110). Regardless of the actual content accessed, the Open Internet model allows for content consumption with little restriction. This is true for other protocols such as HTTP (typically TCP port 80) as well.

### Gates and Controls

With Internet access being granted fully to end terminals, gates and controls are not something that are germane to the model. In fact, this model is “open” due to a lack of control over the end user terminal access. In this model, there are no control points that govern the end user usage.

### Account Management

Without content control, managing a subscriber account is based on the few data points that are available. Those data points are typically the bandwidth consumed by the end user terminal. Therefore, accounting for the packet switch data typically occurs as a flat rate for unlimited access (at a specific bit rate) or per megabyte charge for data transferred. Additional strategies for account management could include service grades that would allow for a variety of port and protocol access. For instance, a “Platinum” level of service might offer full unlimited Internet access, while a “Gold” level might only open HTTP content, while constricting POP3, SMTP, RTSP, RSVP, NPLS, RDP, UDP, Multicast-RDP, and so on.

### Content Provider View

For an easier way to understand the Open Internet model, we can look at the model from a content provider's viewpoint. Referring to FIG. 2, the content provider's viewpoint for an Open Internet model is illustrated with the 3G wireless infrastructure appearing as a conduit to provide services without limitation. When we look at the diagram of FIG. 2, we can see that the wireless service provider really looks insignificant to the content provider, as any limitations have been reduced to terminal capabilities. For instance, the content provider need not worry about service compliance, QoS concerns, security and more. The content provider in this model is rather concerned with the individual device capabilities. These capabilities are typically given at HTTP request time via the HTTP “User-Agent:” header. Therefore, the wireless provider has essentially been bypassed, creating an “Open Internet” for the end user.

### Bandwidth

As a side note, the diagram of FIG. 2 really turns 3G wireless networks into a “pipe,” offering a connection to a terminal. This model clearly promotes the race for bandwidth, which is especially expensive for service providers.

### Technical Issues Around Open Internet

Various technical issues must be considered when deploying an Open Internet strategy. The following sections outline some of the more important technical issues.

Content Support

Content consumption is what drives the Internet. End users consume content whether it is simple web pages, streaming video/audio or purchasing goods and services. With such a wide array of service offerings, support for each of these services will not be all encompassing.

In the Open Internet model, end user terminals are able to navigate and view whatever web pages they desire and, furthermore, consume any services that are offered up by that site. If the site is not prepared to handle the “User-Agent” appropriately, then the pages or service will not render properly. The “User-Agent” is a string in the HTTP header request that identifies the platform hardware, the OS and the browser version installed that is making the request. This allows the server side software to format the pages to display properly.

Furthermore, the Content-Type will most likely not be understood by the terminal platform. The “Content-Type” is a string in the HTTP header response that associates the binary stream that is attached to the response to a given application for rendering. For instance, JPG would be a JPEG image that is displayable by the browser. However, a type of Real-Audio might dictate the Real Player plug-in for content rendering. With PC computers, Content-Types that are not understood by the platform usually result in a “Pop Up” that asks if the user would like to download the appropriate plug-in for this Content Type. In an Open Internet model, a decision to allow or not allow dynamic plug-ins must be a consideration. If dynamic plug-ins are allowed for content support, this will lead to further instability in the terminal and configuration issues, not to mention customer support calls. If the plug-in is not allowed, the content will not be rendered, also resulting in support calls.

Whether or not the user using the terminal will think that the “broken links” are a service provider issue or not is out of scope for this study. The “broken link” is an Internet term used to indicate that the link to the specified content could not be found or could not be rendered. However, it should be noted that, historically, bad terminals do give a perception of bad service.

One attempt to resolve a bulk of these issues is to provide the browser on the terminal with a given set of approved plug-ins. Although this temporarily alleviates the issue, updates to plug-ins are frequent, as software and Internet technologies evolve at a rapid rate.

Customer Support

Customer support is also a technical issue in that the errors experienced by the lack of content support must be quickly identifiable for the volume of calls that will be received by the service provider. For instance, simply displaying an X on the display for un-renderable content is not communicative to the support technician for resolving the issue remotely. The “error” codes and reasons for failures must be thought through up front in order to expedite calls that are received.

If a decision were to be made to allow dynamic plug-in installations on the terminal, the configuration support that the customer support technicians will have to deal with will be diverse as well.

Essentially, the technical issues with opening up the Internet to the terminal are ones that revolve around communication about what went wrong to the customer support technicians. With the number of plug-ins, content types, versions of the platform, OS, browser and all of its sub-systems increasing, the complexity of resolving the problem over the phone is increased greatly.

Configuration

Since opening up the Internet to the terminal requires a decision as to what will be supported and how that support is delivered (see “Content Support”), the potential for configuration issues rises as well. The configuration for the terminal now not only includes all the 3G setup information for simply obtaining an IP address, but the terminal now has complexity in terms of the version of the browser/application, versions and all its sub systems or plug-ins it contains. As an example, a plug-in that contains any technical issues may provide service interruption for other content-types or HTTP service all together.

Open Terminal

When opening up the terminal to access freely all the content on the Internet, the terminal is susceptible to all forms of attack. Far more effort must take place to ensure that the terminal is safe from attacks and, ultimately, the terminal must be designed to “flash” nearly all of its software to provide appropriate countermeasures against attacks.

Content Rendering

One benefit to an open channel to the Internet, while allowing dynamic plug-ins and applets, is that content rendering and service perception will be better for the end user. However, the terminal will now be “open” to attack.

Roaming

Roaming presents itself as a technical issue in that the terminal is left open to roam and consume services while roaming. However, without a clear policy between partners in a roaming environment, roaming may cause issues with service. For instance, moving from one network where the network has an Open Internet model for using as much bandwidth as the user wishes to another network that counts megabytes, will result in a complicated formula for account management and confusion and conflict between subscriber and service provider.

Roaming in general is problematic when one service provider offers other types of controls over access that their partner service provider does not.

Reverse Tunneling

Tunneling is a technique whereby one protocol can wrap itself in another protocol and resurface at another point as itself. For example, if we assume that we have TCP connection whereby application protocols communicate with one another, one protocol has the ability to wrap itself in another protocol to tunnel its way through firewalls or protective schemes. One popular technique is to tunnel other protocols over HTTP to allow those services to surface on the other end. HTTP is a protocol typically allowed by many firewalls and checkpoints. However, tunneling over HTTP will typically hide the underlying protocol. Since terminals in an open Internet model can connect to all types of services, it is possible for hackers to comprise the terminal and reverse tunnel back into the wireless network. At that point, the hacker would have the ability to attempt Denial of Service (DoS) attacks from within the network or simply render the bandwidth to the terminal useless by the amount of traffic already present by the attacker.

Once a reverse tunnel or remote agent is set up on the terminal, the hacker would then also have “inside” access to the network for further hacking.

Hijacking The Air Interface

One of the susceptible issues with Open Internet is the threat of a user “hijacking” the radio air interface. If a hacker were able to do this, the hacker would be granted free bandwidth on the network. From there, the hacker would have the means to NAT his/her connection, thereby blowing open network access to as many people as desired. This issue fundamentally exists in any scheme; yet with an Open Internet model, there are no checks and balances on activity if this were to happen.

Executable Code

The executable code should be left to something similar to a “sandbox” approach that Sun's J2ME provides. If this is not the case, further compromise of the terminal will occur.

Electronic Eavesdropping (Sniffing)

Electronic eavesdropping, also known as sniffing, is a common attack method and security risk. With sniffing, the hacker aims to collect, for example, the user ID and password information. Unfortunately, sniffing programs are publicly available on the Internet for anyone to download.

Spoofing

The information gathered by sniffing can be utilized with a hacking method called spoofing. Spoofing, as a method, means that a hacker uses someone else's IP address and receives packets from the other users. In other words, the hacker replaces the correct receiver in the connection.

Denial of Service (DoS)

In the Denial of Service (DoS) attack, the hacker does not aim to collect information, rather she/he is aiming to cause harm and inconvenience to other users and service providers.

In a typical DoS attack, the hacker generates disturbing traffic which in the worst case jams the target server in such a way that it is not able to provide service anymore. The idea behind this is, for instance, to fill the server's service request queue with requests and then ignore all of the acknowledgments the server sends back. Consequently, the server occupies resources for incoming connection which never occurs. When the timers of the connection expire, the resources are freed to serve another connection attempt. When the buffer containing connection attempts is continuously filled with new requests, the server is actually stuck with these requests and it is not able to provide “real” service. There are many other more sophisticated DoS attacks and plenty of tools are available for DoS attacks on the Internet.

DoS attacks get interesting when combined with other security threats. For instance, a reverse tunnel would open up a terminal and allow a hacker to conduct DoS attacks within the wireless network. Although this is highly unlikely, since this model is open, the hacker has free reign on attempting DoS attacks.

Viruses and Worms

By opening up the terminals to access services directly on the Internet, the terminals are susceptible to viruses and worms. However, it should be noted that the GGSN and other facilities provide “private network” and firewall capabilities and the simple fact of consuming services of all types will create points of vulnerability.

Performance

Performance will be an issue for the network if Open Internet is adopted. For instance, the service providers network would become more of a “pipe” for end users and constant battles for ensuring performance will be required.

Infrastructure

Since the demands for throughput will go up, the infrastructure demands on that network will go up.

Services and Content Issues

In an open model, all services and Internet content is accessible by the end user. This would include any inappropriate content/service or illegal content/service. If there are issues with the legalities for content access, the Open Internet model will just simply not work. Some of these might be:

Illegal or inappropriate content or services;

Illegal pornography;

Unauthorized file sharing that results in bypassing any DRM solution;

Copyrighted movies;

Copyrighted audio.

### Technical Advantages of Open Internet

The main technical advantage to Open Internet is that the system is open. Meaning that there are no additional software and systems necessary to control what users can access. This is far less work than securing the infrastructure.

### CONCLUSION

The open Internet model is one that is very attractive to the end users. However, the technical challenges for the service provider are very great. The vulnerability and models by which to amortize the investment are hard to meet. By opening up the “pipe,” the end-users are free to consume any service that the terminal is capable of rendering or providing. The open Internet model is a very risky venture, for it jeopardizes the integrity of a young new wireless technology.

### SUMMARY OF THE INVENTION

The problems and security risks of the Open Internet model can largely be avoided by the controlled access models that are provided in this specification as alternatives. In the two alternate methods described, control points in the network where secure gated access can be regulated are identified. In both of the preferred implementations described, the Universal Subscriber Identity Module (USIM) is used as a control point for Internet access and transaction analysis. The USIM is a circuit card typically under the control of the service provider that is installed in a wireless cell phone, here generically called the mobile wireless terminal or mobile wireless device. The USIM selectively enables the capabilities of the wireless device according to the subscriber's agreement or plan with the wireless service provider. The USIM is a module in the form of an electronic circuit card that can be removed from the terminal. The USIM or USIM card typically establishes, technically, the relationship between the service provider and the subscriber with regard to the use of the particular terminal hardware in the wireless network available to the service provider.

In managing a subscriber's account, certain features and capabilities of the terminal, usually manufactured by a third party, may be unavailable to the subscriber. By appropriate design of the circuit card and programming of the USIM, operation of the wireless terminal can be controlled and regulated, and the communication transactions analyzed and recorded for management of the subscriber's account.

The use of the USIM to regulate access to the Internet distributes the task responsibility from the service provider to the subscriber's terminal. The service provider is relieved from many of the tasks involved in analyzing each communication transaction for account management.

With Internet access control regulated at the user's mobile terminal, different levels of service can be provided and white lists of approved sites and black lists of disapproved sites can be developed and tailored for a particular subscriber's account plan.

In the detailed description of the preferred embodiments, two methods of account management for Internet access are described that utilize the USIM as the control gate. In managing subscriber accounts, the USIM is provided with, or has access to, a registry of permitted and prohibited Internet sites and preferably includes an account register for calculating and recording any changes made for the media accessed, including content charges, connection charges, a product and service charges. By predefining the subscriber service plan, the service provider for the network access has a means of enforcing the limitations of the subscriber's use of the service provider's wireless network to access the Internet.

These and other features will become apparent from a consideration of the Detailed Description of the Preferred Embodiments set forth in this specification.

### BRIEF DESCRIPTION OF THE DRAWINGS

FIG. 1 is a diagram of the packet switched side of a conventional high level Open Internet for wireless mobile terminals.

FIG. 2 is a diagram of the Internet content provider's conventional view of the wireless mobile terminal.

FIG. 3 is a diagram of a USIM proxy Internet with Internet access control partially distributed to the USIM of the terminal.

FIG. 4 is a diagram of a USIM Internet with Internet access control primarily distributed to the USIM of the terminal.

### DETAILED DESCRIPTION OF THE PREFERRED EMBODIMENTS

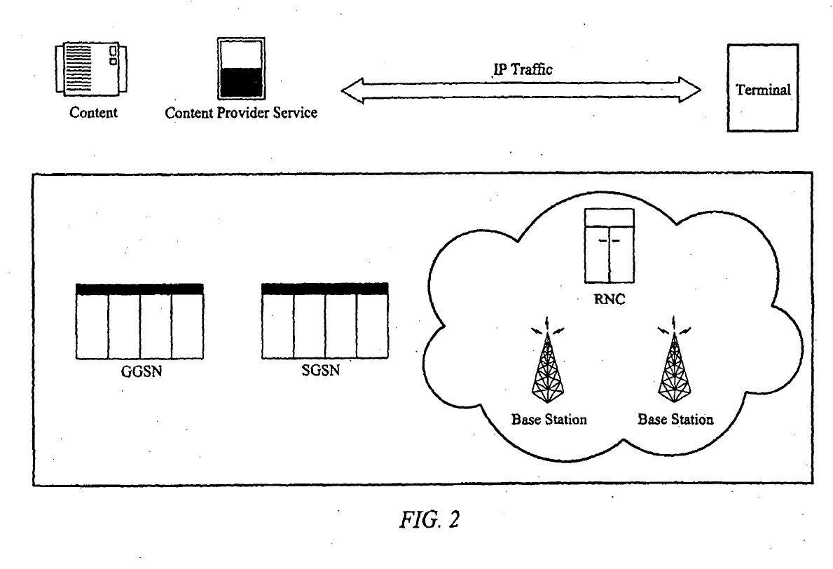

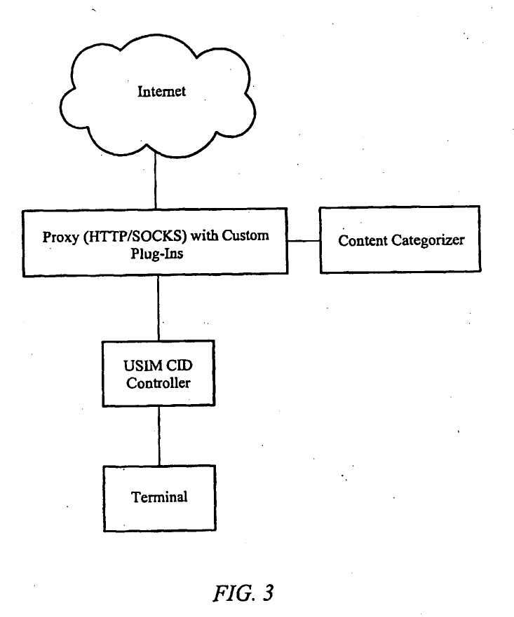

In the preferred embodiments of FIGS. 2 and 3, Internet access control and account management is distributed at least in part to the USIM of the terminal.

### The USIM Proxy Internet

USIM Proxy Internet With Content Stamping

In one embodiment of account management with distributed transaction analysis and access control, a unique model for enforcing a control point is to stamp the content with a content identifier or CID which tells the USIM to allow or disallow access to the content. Many proxies allow programmatic coding for plug-ins to extend the capabilities. Some famous companies that have done this are companies like Akamai. Akamai started with something similar to a Squid cache and extended the capabilities for their network via plug-ins. A new technique could be used to qualify classes of content based on the site or the actual service/content, being requested. Since the HTTP 1.0 and 1.1 specifications allow for additional header information that does not affect anything between the two endpoints, the new proxy would qualify the content by stamping the content item with a CID. CIDs could then be categorized into levels with different charges. For instance, if an end user were to have a Platinum service, they might have access to all of the CID categories. The USIM would then assist or actually “gateway” the access to the various CID categories. However, if the user has basic service, they might only have access to basic sites and content.

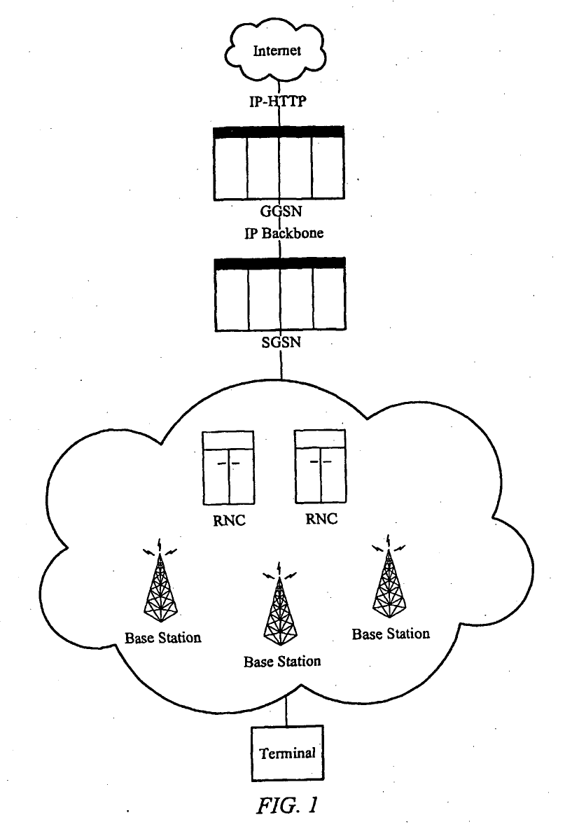

The diagram of FIG. 1 illustrates a USIM Proxy Internet.

### Gates and Controls

The major control points in the USIM Proxy Internet are at two locations. The first is the USIM that contains the subscriber service level and only allows content with the appropriate service level to be consumed. The other control point is at the Proxy, whereby the USIM transmits its CID service level in the HTTP header which tells the Proxy what content the USIM has access to.

### Account Management

Account management is accomplished through analyzing transaction events from the Proxy server. An additional Proxy plug-in can be used to track accounting events and store them for capture by a subscriber system to manage the subscriber's account. Since the user is relatively restrained within their service level, this non real-time accounting process should be acceptable. The USIM Proxy Internet has certain technical disadvantages:

Technical Issues with USIM Proxy Internet

Flexibility

Although the USIM Proxy Internet system has many great advantages, the basic flexibility in the system is low. Furthermore, whenever fundamental changes or service offerings are desired, both the Proxy software and the USIM may potentially need to be changed.

Infrastructure Changes

This system will require joint deployment of both Proxy systems combined with USIM updates to work hand in hand to provide this service. Therefore, the infrastructure will have to change to accommodate this model.

Application Support

Not all applications use HTTP to communicate. Although a SOCKS style Proxy could be used, not all protocols will lend themselves nicely to CID stamping. For instance, Microsoft's MMS provides no such facility. However, Real Player's RTSP would and RDP would not.

### Technical Advantages

On the otherhand, the USIM Proxy Internet has certain technical advantages:

Natural Internet Flow

One clear advantage to combining a Proxy with USIM and CID categories is that it models the Internet model well. Proxies are almost a mandatory part of any serious HTTP infrastructure and USIMs contain end users credentials and personalization information. By combining these two elements, the two services are married nicely.

Scalability

This solution scales well in that Proxies can be added in traditional linear or waterfall fashion to service large network demands. By keeping the service level in the USIM, the end user automatically tells the Proxies what types of content they can access. This allows the Proxies to not work hard and actually creates a true distributed solution in that the Proxy does not have to “ask” another system to make a decision but can work fairly autonomously.

### CONCLUSION

The USIM Proxy Internet solution is a viable solution in that it really adopts the best practices for Internet technologies while allowing user preferences and credentials to exist in the USIM. However, a pure USIM solution offers similar capabilities with fewer technical issues. Regardless of whether or not this is actually implemented, the Proxies and waterfall techniques should be integrated to save on overall network demands for 3G wireless networks.

### The USIM Internet

### USIM Internet Model

USIM Internet is another embodiment of a subscriber account management system utilizing a model where the control point resides in the USIM for Internet access. USIM Internet is a technology (e.g., Java Card Applet) that resides in the USIM that is a single point of transactional analysis and access control where the end-users of the terminal hardware would be required to pass through this technology for services and content consumption.

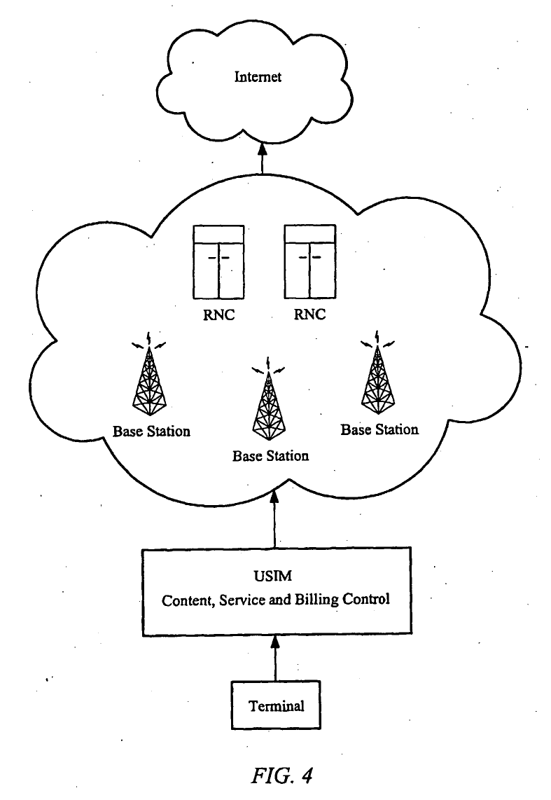

As shown in the diagram of FIG. 4, the simple flow for USIM Internet access is controlled at the terminal by the USIM.

### USIM Internet-Network Flow

In a USIM controlled Internet access model, the network traffic flow would fundamentally be that of an Open Internet network flow except before accessing the Internet, the terminal would be required to request permission from the USIM via the USAT protocol. The terminal would be required to request permission before acquiring an IP address and connecting via IP using TCP/UDP to various protocol ports for Internet services. For instance, the USIM could grant or restrict the terminal's email client the connection to POP3 (typically TCP port 110). In another instance, the USIM could grant or restrict the access to content (i.e., MP3 Audio, JPEG Video, H.261 Videoconferencing, etc.) based on the content-type via HTTP (typically TCP port 80).

Another advantage of USIM flow control is that the USIM could restrict the end-user's access to particular sites and limit authorization for particular content items (black lists). Also, USIM flow control can facilitate access to other sites and authorize selection of particular content items (white lists). This is all supported in the current HTTP 1.0 and 1.1 protocol specifications.

### Gates and Control

In the USIM Internet model the control point resides in the USIM and some of the advantages of this are:
All Internet access is controlled by a single consistent software application (e.g., USIM Java Card Applet). Having this single control point allows for various types of monitoring and transaction analysis to occur.
End-users can freely roam on other networks regardless of the Internet model adopted by other roaming networks.
End-users can swap their USIM cards into other terminals, keeping the same access and control conditions.

### Account Management

In a USIM Internet model, transactional events can be analyzed at the terminal by the USIM according to pre-set account management protocols, since all Internet access is moving through a single control point. Account reports can be generated and recorded at the terminal for use by both the service provider and the subscriber. This model would also allow end-users to roam on other networks with accurate accounting for permitted services used regardless of the Internet model adopted by the other networks.

### Technical Issues With USIM Internet

Security

In the USIM Internet model, the control point resides in the USIM and relies on the security of the USIM. If the USIM is hacked, the control point for Internet access is compromised. One solution is to have an authentication procedure between the terminal and the USIM to determine the authenticity of the USIM.

Memory

In the USIM Internet model, the application (e.g., Java Card Applet) and access/account information are stored on the USIM and memory is limited (i.e., 128K).

As a side note, USIM memory (e.g., access and account information) can be dynamically updated as needed via the Bearer Independent Protocol (BIR), using logical channels.

### Technical Advantages With USIM Internet

Implementation

The following are advantages of the USIM Internet model with respect to implementation:
Development. There would be less development in the USIM Internet model than other Internet models.
Infrastructure. The impact on the infrastructure would be
Cost. The cost would be considerably less for the USIM Internet model than the other Internet models.

Scalability

Scalability would not be an issue for the USIM Internet model since the processing of Internet access is distributed to each USIM (i.e., distributed processing model).

Roaming

A major technical advantage to the USIM Internet model is roaming. Since the control point resides in the USIM, end-users can roam freely on other networks and have the same Internet access control as their home network, regardless of the Internet model adopted by the roaming networks.

### CONCLUSION

The USIM Internet model provides for Internet access control that is cost effective, scalable, easily implemented and has little impact on the infrastructure of the network. Since the control point resides in the USIM, transactional analysis and access control can trigger accounting events which can be captured and recorded real-time for service and content consumption. This model allows for end-users to freely roam on other networks, regardless of the Internet model adopted by the roaming networks.

The Open Internet is attractive due to the lack of work that is required to implement controls, but leaves the system vulnerable. The first solution looks at a USIM Proxy Internet as a hybrid model, where the ideals of both the Internet and wireless subscriber are married. The second solution looks at the USIM Internet model as a pure USIM solution. This is attractive in that all the access is controlled at the USIM level. This is advantageous in that all personalization, decisions about personalization, and access occur in the USIM. Proxies can still be used in this model, but they would not have CIDs. The USIM model also allows for controlled access to various other protocol ports, such as MMS for Microsoft or RTSP/RDP for other audio and video services.

1. A method for open Internet security for mobile wireless devices comprising the steps of:
providing a mobile wireless device with capabilities, including the capability to connect to the Internet via a wireless communication network at least in part controlled by a wireless network service provider; and,
providing the mobile wireless device with a USIM controlled by the wireless service provider, wherein the USIM is programmed to selectively enable certain capabilities of the mobile wireless device and control access to the Internet.

2. The method of claim 1, wherein the control of access to the Internet is regulated by the USIM according to predetermined criteria.

3. The method of claim 2, wherein the predetermined criteria restricts access to a list of approved Internet web sites.

4. The method of claim 2, wherein the predetermined criteria restricts access to a list of approved web pages.

5. The method of claim 2, wherein the predetermined criteria restricts access to approved Internet services.

6. The method of claim 2, wherein the predetermined criteria restricts access to approved Internet products.

7. The method of claim 2, further comprising the step of providing an intermediate proxy service between Internet content, service and product providers that qualifies the content of the transmissions of the Internet content, service and product providers to the subscribers of the wireless network service providers and stamps the content of the transmission with a content identifier;
categorizing the content identifiers into different classes; and,
programming the USIM of a subscriber to allow access to only predetermined classes.

8. The method of claim 7, wherein the content identifiers are categorized in different levels and wherein the USIM of the subscriber allows access to selected levels according to a subscriber plan.

9. The method of claim 8, wherein the charges for different levels are different and the access to selected levels is provided according to the level of service provided in the subscriber plan.

10. The method of claim 7, comprising the further step of analyzing the transaction events for a selected subscriber USIM and accounting for transmissions allowed to the subscriber by the subscriber's USIM.

11. A mobile wireless device, operable in a wireless communication network at least in part controlled by a wireless network service provider that provides wireless network services to subscribers, comprising:
a mobile wireless terminal having electronics capable of communicating in the wireless communication network and capable of connecting to the Internet; and,
a removable circuit card installable in the mobile wireless terminal, the removable circuit card being controlled by the wireless network service provider, wherein the removable circuit card is provided to a subscriber of the service provider and defines the subscriber's access to the service provider's wireless communication network and to the Internet through the service provider's wireless communication when the circuit card is installed in the mobile wireless terminal.

12. The mobile wireless device of claim 11, wherein the removable circuit card comprises a USIM.

13. The mobile wireless device of claim 11, wherein the removable circuit card is programmed to selectively control access to the Internet.

14. The mobile wireless device of claim 11, wherein the removable circuit card is programmed to process content identifiers for blocking access to Internet content having certain predesignated content identifiers, wherein the content identifiers are established by a proxy in association with the service provider.
